(19) United States
(12) Patent Application Publication
(10) Pub. No.: US 2007/0019969 A1
(43) Pub. Date: Jan. 25, 2007

(54) Apparatus and method for converting optical signal into electrical signal

(76) Inventors: Cheng-chung Shih, Fremont, CA (US); Yuh-Min Lin, San Ramon, CA (US)

Correspondence Address: SEARETE LLC;CLARENCE T. TEGREENE, 1756 - 114TH AVE., S.E., SUITE 110, BELLEVUE, WA, 98004, US

(21) Appl. No.: 11/515,046

(22) Filed: Sep. 5, 2006

Related U.S. Application Data
(63) Continuation-in-part of application No. 11/174,456, filed on Jul. 6, 2005.

(51) Int. Cl. H04B 10/06

(52) U.S. Cl. 398/202

(57) ABSTRACT

An apparatus and a method for converting optical signal into electrical signal are disclosed. The apparatus includes a photo diode (PD) and a charge pump circuit. The PD receives an optical signal. The optical signal is then converted into a current signal. The charge pump circuit is electrically connected to the PD and performs a charge-discharge to generate a pulse signal based on the current signal. The characteristic of the pulse signal relates to the intensity of the optical signal.

### FIELD OF THE INVENTION

The present invention relates to an apparatus and a method for converting an optical signal into an electrical signal, and more particularly to an apparatus and a method for converting an optical signal into a pulse signal.

### BACKGROUND OF THE INVENTION

At present, it is very popular to apply a photo diode for detecting an optical signal. For instance, a photo diode configured in a screen of a mobile phone is used for detecting an ambient light, and the light of the screen is adjusted based on the intensity of detected ambient light for saving power; or the photo diode configured in a monitoring camera is used for detecting an ambient light, such that if the intensity of ambient light is too weak, then an auxiliary light source will be activated for capturing a clear image of an object. Most of the present applications usually measure the current generated by photo diode due to the projection of optical signal to determine the intensity of the optical signal. However, the current is too small, and thus the traditional measurements cannot achieve a high precision.

In view of the foregoing shortcomings of the prior art, the inventor of the present invention based on years of experience in the area of optoelectric circuit development, and finally invented an apparatus and a method for converting an optical signal into an electrical signal to overcome the foregoing shortcomings.

### SUMMARY OF THE INVENTION

Therefore, it is a primary objective of the present invention to provide an apparatus and a method for converting an optical signal into an electrical signal to improve the accuracy of converting optical signals into electrical signals.

To achieve the foregoing objective, the present invention provides an apparatus for converting optical signal into electrical signal that comprises a photo diode, a charge pump circuit and a transistor. The photo diode is provided for receiving an optical signal and converting the optical signal into a current signal. The charge pump circuit is electrically connected to the photo diode for performing a charge-discharge based on the current signal to generate a pulse signal, and the characteristic of the pulse signal relates to the intensity of the optical signal.

The present invention further provides a method of converting an optical signal into an electric signal that comprises the steps of: using a photo diode to receive an optical signal, and converting the optical signal into a current signal; electrically connecting a charge pump circuit to the photo diode, and the charge pump circuit performs a charge-discharge based on the current signal to generate a pulse signal; and determining the intensity of the optical signal based on the characteristic of the pulse signal.

The foregoing characteristic of the pulse signal is the cycle of the pulse signal, the number of pulse signals, the ratio of a positive pulse cycle to a negative pulse cycle of the pulse signal, or the integration of a pulse area of the pulse signal.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a block diagram of an apparatus for converting an optical signal into an electrical signal in accordance with the present invention;

FIG. 2 is a schematic view of an apparatus for converting an optical signal into an electrical signal in accordance with a preferred embodiment of the present invention;

FIG. 3 is a schematic view of an apparatus for converting an optical signal into an electrical signal in accordance with another preferred embodiment of the present invention; and

FIG. 4 is a flow chart of a method for converting an optical signal into an electrical signal in accordance with the present invention.

### DETAILED DESCRIPTION OF THE PREFERRED EMBODIMENTS

In the following figures of an apparatus and a method for converting optical signal into electrical signal in accordance with the preferred embodiments of the present invention, the same numerals are used to label the same respective elements for the illustration purpose.

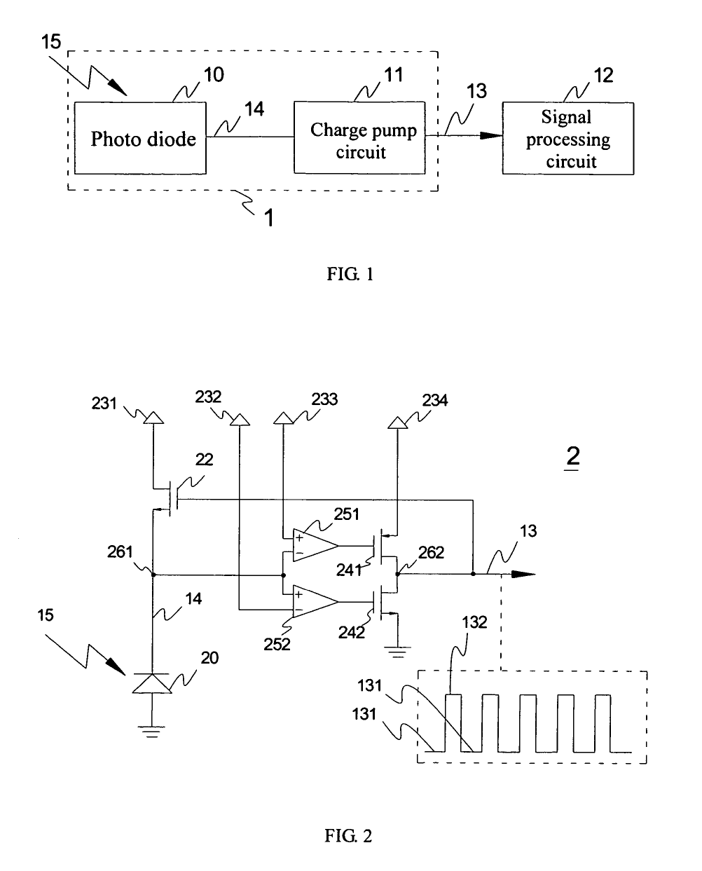

Referring to FIG. 1 for a schematic view of an apparatus for converting optical signal into electrical signal in accordance with the present invention, the apparatus for converting optical signal into electrical signal 1 comprises a photo diode 10 and a charge pump circuit 11. The photo diode 10 is provided for receiving an optical signal 15, and converting an optical signal 15 into a current signal 14. The charge pump circuit 11 is electrically connected to the photo diode 10 and performs a charge-discharge based on the current signal 14 to generate a pulse signal 13, and the characteristic of the pulse signal 13 relates to the intensity of the optical signal 15. The characteristic of the pulse signal 13 could be the cycle of the pulse signal 13, the number of pulse signals 13, or the ratio of a positive pulse cycle to a negative pulse cycle of the pulse signal 13. A signal processing circuit 12 is electrically connected to the charge pump circuit 11 for receiving the pulse signal 13 to estimate the intensity of an optical signal 15. The signal processing circuit 12 is preferably a counter circuit, a timer circuit, an integration circuit or a low-pass filter circuit.

Referring to FIG. 2 for a schematic view of an apparatus for converting optical signal into electrical signal in accordance with a preferred embodiment of the present invention, the apparatus for converting optical signal into electrical signal 2 comprises a photo diode 20, three transistors 22, 241, 242, and two comparators 251, 252. A positive input terminal of the comparator 251 is electrically connected to a constant voltage source 233 (having a voltage VH), a negative input terminal of the comparator 251 and a positive input terminal of the comparator 252, and a negative input terminal of the comparator 252 is electrically connected to a constant voltage source 232 (having a voltage VL), and the voltage VH is greater than the voltage VL. A gate of the transistor 22 is electrically connected to a node 262, and a source is electrically connected to a node 261, and a drain is electrically connected to a constant voltage source 231, and its voltage is VH. A gate of the transistor 241 is electrically connected to an output terminal of the comparator 251, and its source is electrically connected to a constant power supply 234 (having a voltage VM), and its drain is electrically connected to a drain of the transistor 242. A gate of the transistor 242 is electrically connected to an output terminal of the comparator 252, and a source of the transistor 242 is grounded.

The initial state of the transistor 22 is an OFF state, and the voltage of the node 261 is equal to VH. If the optical signal 15 is projected onto the photo diode 20, the photo diode 20 will generate a current signal 14 flowing from a positive terminal of the photo diode 20 to a negative terminal of the photo diode 20 by an optotelectric conversion, such that the voltage of the node 261 will drop. When the voltage of the node 261 becomes lower than the voltage VL, then the comparator 251 will output a positive signal and the comparator 252 will output a negative signal, so that the transistor 241 will enter into an ON state and the transistor 242 will enter into an OFF state. The voltage of the node 262 will become VM (a partial signal 132). The voltage at a gate of the transistor 22 is greater than the voltage at a collector of the transistor 22, so that the transistor 22 will enter into an ON state, and the voltage of the node 261 is charged by a constant voltage source 231 to rise to VH. If the voltage of the node 261 is equal to VH, then the comparator 252 will output a positive signal. The transistor 242 will enter into an ON state, and thus the voltage of the node 262 will become zero (a partial signal 131), and the transistor 22 will enter into an OFF state. The photo diode 20 will generate a current due to the projection of the optical signal 15, so that the voltage of the node 261 will drop, and the foregoing procedure will be repeated.

In the abovementioned procedure, if the optical signal 15 is projected onto the photo diode 20 continuously, then the voltage of the node 262 will be changing unceasingly between VM and 0 to form a pulse signal 13. The intensity of the current generated by the photo diode 20 is directly proportional to the intensity of the optical signal 15. If the intensity of the optical signal 15 is stronger, then the current generated by the photo diode 20 will be greater. Therefore, the time for the voltage of the node 261 to drop from VH to VL will be shorter, and the length of the partial signal 131 will be smaller. On the other hand, if the intensity of the optical signal 15 is weaker, the current generated by the photo diode 20 will be smaller, and thus the time for the voltage of the node 261 to drop from VH to VL will be longer, and the length of the partial signal 131 will be greater. Therefore, a counter circuit can be configured for receiving such pulse signal and calculating the number of pulses within a fixed time to estimate the intensity of the optical signal 15.

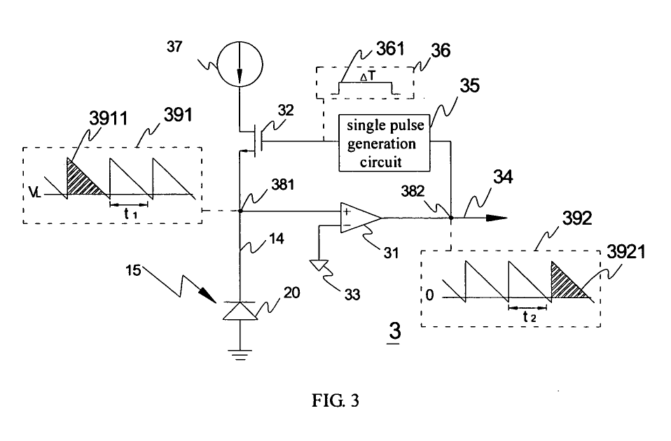

Referring to FIG. 3 for a schematic view of an apparatus for converting optical signal into electrical signal in accordance with another preferred embodiment of the present invention, the apparatus for converting optical signal into electrical signal 3 comprises a photo diode 20, a transistor 32, a comparator 31 and a single pulse generation circuit 35. A positive terminal of the photo diode 20 is grounded, and its negative terminal is electrically connected to a collector of the transistor 32, and a gate of the transistor 32 is electrically connected to an output terminal of the single pulse generation circuit 35, and a drain of the transistor 32 is electrically connected to constant current source 37 (whose electrical fluid is I), and a source of the transistor 32 is electrically connected to the node 381. A positive input terminal of the comparator 31 is electrically connected to a node 381, and a negative input terminal of the comparator 31 is electrically connected to a constant voltage source 33 (whose voltage is VL), and an output terminal of the comparator 31 is electrically connected to a node 382. An input terminal of the pulse generation circuit 35 is electrically connected to the node 382.

If the initial state of the transistor 32 is an OFF state and the voltage of the node 381 is VH, then VH will be greater than VL. If the optical signal 15 is projected onto the photo diode 20, the photo diode 20 will generate a current signal 14 flowing from a positive terminal of the photo diode to a negative terminal of the photo diode due to an optoelectric conversion, such that the voltage of the node 381 will drop. When the voltage of the node 381 becomes lower than VL, the input terminal of the comparator 31 will generate a negative signal, such that the pulse generation circuit will generate a pulse signal 36 with a positive pulse portion 361 of a fixed cycle □T, and output the pulse signal 36 to a gate of the transistor 32. The transistor 32 is maintained at an ON state since the pulse signal 36 falls within □T. When the transistor 32 is maintained at an ON state, the voltage of the node 381 will be increased to a voltage VL+I×□T due to the charge of the constant current source 37. After the time □T, the transistor 32 will enter into an OFF state. In the foregoing procedure, if the optical signal 15 is projected onto the photo diode 20 continuously, then the voltage signal 391 of the node 381 and the voltage signal 392 of the node 382 will become pulse signals.

If the intensity of the optical signal 15 is stronger, then the current generated by the photo diode 20 will be greater, and thus the voltage of the node 381 and the node 382 will drop faster. On the contrary, if the intensity of the optical signal 15 is weaker, then the current generated by the photo diode 20 will be smaller, and thus the voltage of the node 381 and the node 382 will drop slower. Therefore, a measure circuit can be installed for measuring a time interval t1 for the voltage signal 391 of the node 381 passing through the voltage VL for two times or a time interval t2 for the voltage signal 392 of the node 382 passing through the voltage 0 for two times. The measured time is used for estimating the intensity of the optical signal 15. Alternatively, an integration circuit is installed for measuring a cumulative voltage for the voltage signal 391 of the node 381 passing through the voltage VL (which is the area 3911) for two times or a cumulative voltage for the voltage signal 392 of the node 382 passing through the voltage 0 (which is the area 3921) for two times. The measured cumulative voltage is used for estimating the intensity of the optical signal 15.

The foregoing two preferred embodiments are provided for the illustration of the present invention, but not intended for limiting the invention. Any charge pump circuit comprised of a feedback circuit and a signal comparison circuit, or any feedback circuit based on an output signal of a signal comparison circuit for controlling a charge-discharge is covered in the claims of the present invention. The feedback circuit is preferably a transistor, and the signal comparison circuit preferably comprises at least one transistor and at least one comparator or preferably comprises a comparator and a single pulse generator.

Further, the pulse signal of the signal comparison circuit can be sent to a signal processing circuit such as a counter circuit, a timer circuit, an integration circuit or a low-pass filter circuit, and the signal processing circuit estimates the intensity of an optical signal based on the cycle of the pulse signal, the number of pulses of the pulse signal, the ratio of a positive pulse cycle to a negative pulse cycle of the pulse signal, or the integration of pulse area of the pulse signal. However, the foregoing description is used for illustration only and not intended to limit the invention. Any application of estimating the intensity of an optical signal by the characteristic of a pulse signal is intended to be covered in the claims of the present invention.

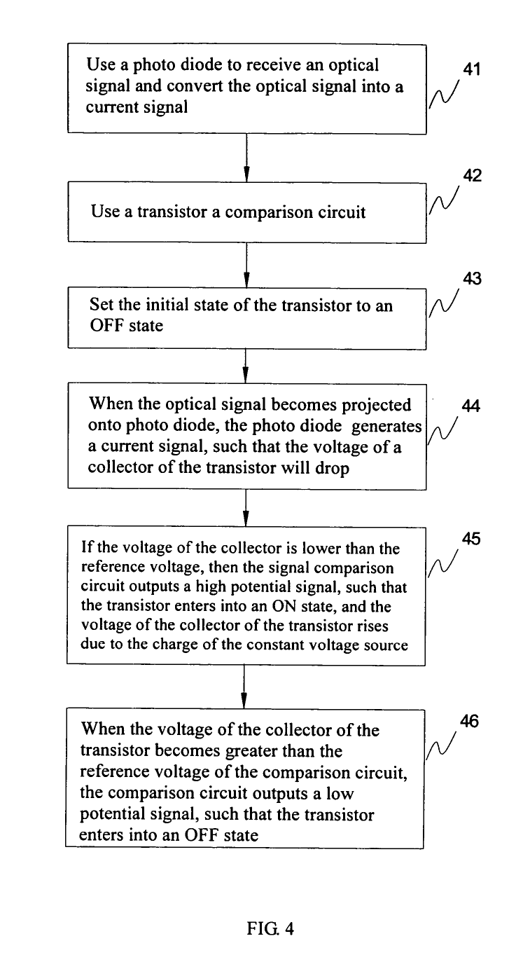

Referring to FIG. 4 for a flow chart of a method for converting an optical signal into an electrical signal in accordance with the present invention, the method comprises the following steps:

Step 41: A photo diode is used for receiving an optical signal and converting the optical signal into a current signal.

Step 42: In a transistor, its source is electrically connected to a negative terminal of the photo diode, its drain is electrically connected to a constant voltage source, and its gate is electrically connected to an output terminal of a signal comparison circuit, and an input terminal of the signal comparison circuit is electrically connected to a source of a transistor, and the voltage of the constant voltage source is higher than a reference voltage of the signal comparison circuit.

Step 43: The initial state of the transistor is set to an OFF state, and the voltage of a source of the transistor is greater than a reference voltage of the signal comparison circuit.

Step 44: If the optical signal is projected onto a photo diode, the photo diode will generate a current signal, such that the voltage of a source of the transistor will drop.

Step 45: When the voltage of the source of the transistor becomes lower than the reference voltage of the signal comparison circuit, then the signal comparison circuit will output a high potential signal, such that the transistor will enter into an ON state, and the voltage of the source of the transistor will rise due to the charge of the constant voltage source.

Step 46: When the voltage of the collector of the transistor becomes greater than the reference voltage of the signal comparison circuit, the signal comparison circuit will output a low potential signal, such that the transistor will enter into an OFF state.

If the optical signal is projected onto the photo diode continuously, then Steps 44, 45 and 46 will be executed repeatedly, so that the signal comparison circuit will repeatedly output a high potential signal and a low potential signal to form pulse signals.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for converting optical signal into electrical signal, comprising: a photo diode, for receiving an optical signal, and converting said optical signal into a current signal; and
a charge pump circuit, electrically connected to said photo diode, for performing a charge-discharge based on said current signal to generate a pulse signal, and the characteristic of said pulse signal relates to the intensity of said optical signal.

2. The apparatus for converting optical signal into electrical signal of claim 1, wherein the characteristic of said pulse signal is the cycle of said pulse signal, the number of said pulse signals, or the ratio of a positive pulse signal to a negative pulse of said pulse signal.

3. The apparatus for converting optical signal into electrical signal of claim 1, further comprising a counter, an integrator, a timer circuit or a low-pass filter, for estimating the intensity of said optical signal based on said pulse signal.

4. The apparatus for converting optical signal into electrical signal of claim 1, further comprising a constant voltage source or a constant current source as a charge power supply.

5. The apparatus for converting optical signal into electrical signal of claim 1, wherein said charge pump circuit comprises a feedback circuit and a signal comparison circuit, and said feedback circuit is provided for receiving an output signal of said signal comparison circuit and controlling said charge-discharge based on said output signal.

6. A method for converting optical signal into electrical signal, comprising the steps of:
using a photo diode to receive an optical signal, and converting said optical signal into a current signal;
electrically connecting a charge pump circuit to said photo diode, and said charge pump circuit performing a charge-discharge based on said current signal to generate a pulse signal; and
determining the intensity of said optical signal based on the characteristic of said pulse signal.

7. The method for converting optical signal into electrical signal of claim 6, wherein the characteristic of said pulse signal is the cycle of said pulse signal, the number of said pulse signals, the ratio of a positive pulse signal to a negative pulse of said pulse signal, or the integration of a pulse area of said pulse signal.

8. The method for converting optical signal into electrical signal of claim 6, further using a counter, an integrator, a timer circuit or a low-pass filter to estimate the intensity of said optical signal based on said pulse signal.

9. The method for converting optical signal into electrical signal of claim 6, further using a constant voltage source or a constant current source as a charge power supply.

10. The method for converting optical signal into electrical signal of claim 6, wherein said charge pump circuit comprises a feedback circuit and a signal comparison circuit, and said feedback circuit is provided for receiving an output signal of said signal comparison circuit, and controlling said charge-discharge based on said output signal.
